(19) United States
(12) Patent Application Publication
(10) Pub. No.: US 2009/0054051 A1
(43) Pub. Date: Feb. 26, 2009

(54) Attachable Headset for Portable Device

(76) Inventor: James Cavallo, Pittsburgh, PA (US)

Correspondence Address: Jeffrey C. Hood;Meyertons Hood Kivlin Kowert & Goetzel PC, P.O. Box 398, Austin, TX, 78767-0398, US

(21) Appl. No.: 11/843,018

(22) Filed: Aug. 22, 2007

(51) Int. Cl. H04M 3/00

(52) U.S. Cl. 455/420

(57) ABSTRACT

System and method for attaching a wireless headset to a portable device. The wireless headset may include a data receiver for receiving data from a portable device and a physical mechanism to attach to the portable device. The wireless headset may be detachable from the portable device, and after being detached, the headset may be usable for listening to audio data received from the portable device via the data receiver. The wireless headset may further include a data transmitter for providing data to the portable device. Additionally, the wireless headset may be operable to charge its battery when attached to the portable device. Furthermore, detaching the wireless headset may be used to answer a call if the portable device is capable of telecommunication services.

### FIELD OF THE INVENTION

The present invention relates to the field of wireless headsets, and more particularly to a wireless headset for a portable device.

### DESCRIPTION OF THE RELATED ART

Increasingly, users have adopted portable and mobile devices for use while away from their home or work. For example, users often carry or own portable devices which provide telecommunication services (e.g., mobile telephones and laptops), audio play back (e.g., mp3 players), GPS, scheduling features (e.g., personal digital assistants (PDAs)), and/or other services. Generally, these portable devices provide or receive audio data from the user.

Accordingly, many such users also own and use headsets or headphones to receive/provide audio data to the portable device. For example, many mobile telephones are capable of communicating with a headset which receives and provides audio data from/to the portable device. Unfortunately, when the headset is a wireless device, it must be carried and/or charged separately, and requires that the user keep track of and maintain both the headset and the portable device.

In light of this, improvements in headsets and portable devices are desired.

### SUMMARY OF THE INVENTION

Various embodiments are presented of a headset for a portable device. TO BE COMPLETED AFTER REVIEW.

### BRIEF DESCRIPTION OF THE DRAWINGS

A better understanding of the present invention can be obtained when the following detailed description of the preferred embodiment is considered in conjunction with the following drawings, in which:

FIGS. 1A and 1B illustrate an exemplary portable device and wireless headset according to one embodiment;

FIG. 2 illustrates the portable device and wireless headset of FIGS. 1A and 1B physically attached according to an embodiment; and

FIG. 3 is a flowchart diagram illustrating one embodiment of a method for attaching a wireless headset to a portable device.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

### Terms

The following is a glossary of terms used in the present application:

Memory Medium—Any of various types of memory devices or storage devices. The term “memory medium” is intended to include an installation medium e.g., a CD-ROM, floppy disks, or tape device; a computer system memory or random access memory such as DRAM, DDR RAM, SRAM, EDO RAM, Rambus RAM, etc.; or a non-volatile memory such as a magnetic media, e.g., a hard drive, optical storage, flash memory, etc. The memory medium may comprise other types of memory as well, or combinations thereof. In addition, the memory medium may be located in a first device in which the programs are executed, or may be located in a second different device which connects to the first device over a network, such as the Internet. In the latter instance, the second device may provide program instructions or data to the first device for execution or reference. The term “memory medium” may include two or more memory mediums which may reside in different locations, e.g., in different computers that are connected over a network.

Software Program—the term “program” or “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Portable Device—any of various types of computer systems which are mobile or portable, including laptops, PDAs, mobile or mobile telephones, handheld devices, portable Internet devices, music players, data storage devices, etc. In general, the term “portable device” can be broadly defined to encompass any electronic, computing, and/or telecommunications device (or combination of devices) which is easily transported by a user.

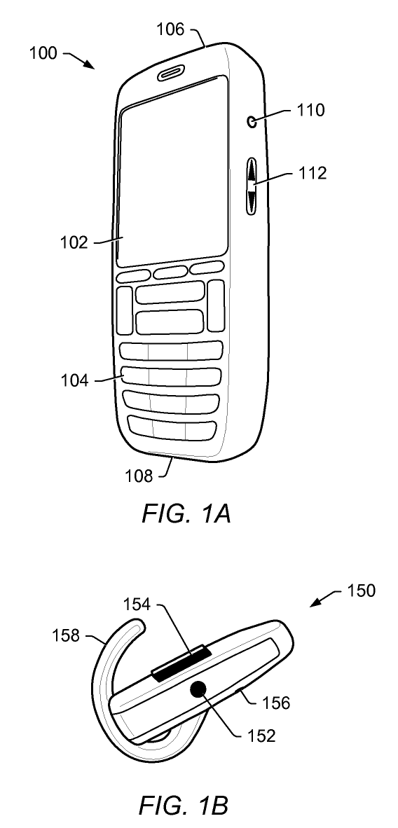

### FIGS. 1A and 1B—Exemplary Portable Device and Headset

FIGS. 1A and 1B illustrate an exemplary portable device 100 and an exemplary headset 150. As shown, the portable device includes a display 102, interface buttons 104, power button 106, docking/charging port 108, audio port 110, and volume controls 112. Note that these elements are exemplary only and that any of these features may be removed or substituted with others as desired. Note further that the shape and type of the portable device 100 is exemplary only. For example, while the current exemplary portable device 100 resembles a PDA or mobile telephone, the portable device 100 may be a portable computer or laptop, among other types of form factors/portable devices. Furthermore, in some embodiments, the interface buttons 104 may be removed or replaced with a single interface button. Additionally, or alternatively, the display may be a touch or multi-touch display which may receive input via the user touching the display, e.g., with fingers, stylus, etc. Furthermore, the portable device may include one or more ports for peripherals, e.g., keyboards, mice, microphones, etc.

The portable device 100 may include one or more processors and memory mediums for executing programs and/or Operating System(s). The programs stored in the memory medium may be executable to perform functionality of the portable device 100. For example, the portable device 100 may store a program for playing audio files on the portable device, making telephone calls, browsing the Internet, checking email, etc.

FIG. 1B illustrates an exemplary headset 150 usable in conjunction with the portable device 100. More specifically, the headset 150 may be used to receive and/or transmit data (e.g., audio data) from/to the portable device 100, e.g., via a data receiver and/or a data transmitter included in the headset 150. In some embodiments, the headset may be wireless headset, e.g., a Bluetooth® headset, which may transmit and receive the data from the portable device 100 according to various wireless communication protocols (e.g., Bluetooth® communication protocols, among others). Additionally, the headset 150 may include a rechargeable battery which may be charged individually (e.g., via a power adapter) and/or when coupled to the portable device 100 (described in more detail below). Accordingly, the headset 150 may include a docking port 154 for attaching to a port of the portable device 100 and/or a power port 156 for attaching to a power supply. Note that these ports are exemplary only and may be removed or substituted as desired. For example, in one embodiment, the headset 150 may include a single port for coupling to the portable device 100 or may include two or more ports for coupling to the portable device 100, a power supply, and/or other devices, as desired. The ports may be male or female (or other) as desired. Finally, the headset may include a portion 158 for wrapping or holding on to a user's ear.

As shown, the headset 150 may include one or more interface buttons 152. For example, the headset 150 may include one or more buttons for interacting with functionality of the portable device 100 (e.g., stopping, starting, pausing, fast forwarding, rewinding, etc. music playback, accepting or rejecting a phone call, etc.).

Thus, a user may use the headset 150 in conjunction with the portable device 100 while using functionality of the portable device 100.

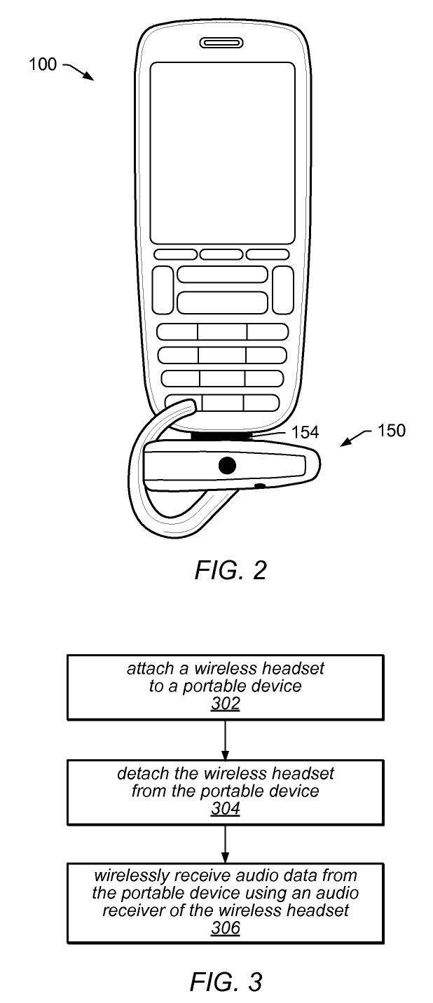

### FIG. 2—Exemplary Combination of a Portable Device and Headset

FIG. 2 illustrates an exemplary combination of the portable device 100 and the headset 150. As shown, the two devices are attached such that the two devices may act or may be carried as a single device. As used herein, two devices being “attached” refers to the two devices being physically coupled and within close proximity to each other. For example, the portable device 100 and/or the headset 150 may include physical mechanisms for coupling to each other such that they act as a single unit. In one embodiment, the portable device and the headset may attach using a harness. For example, the portable device 100 may include a seat or harness (e.g., on the device itself or on a case of the device) that the headset 150 may sit in. In some embodiments, the portable device 100 and the headset 150 may snap or lock together such that they are fixedly attached until the user unsnaps or unlocks the two devices. Alternatively, the portable device 100 and the headset may attach to each other magnetically.

In one embodiment, the headset 150 may attach to a port of the portable device 100. For example, the headset may include a male adaptor which may insert into a female port, e.g., the docking/charging port 108, of the portable device 100. In some embodiments, the headset 150 may attach to a port of the portable device 100, but may still allow for the port to be used (e.g., by other peripherals, power supplies, etc.). For example, in one embodiment, the headset 150 may include an adaptor for plugging into a port, e.g., the docking/charging port 108, of the portable device 100 and may also include a female adaptor of the same type. In doing so, the headset may simply insert between the power source and the phone, e.g., for charging the battery of the headset 150, without affecting operation or charging of the portable device 100. In one embodiment, the headset may include a port which may not be the same port of the portable device 100 to which it plugs into, but may instead interconvert between the two types of ports. Correspondingly, the headset may act as a converter between different port types, as desired. Additionally, similar to above, the headset may be operable to charge via charge supplied to the port of the headset. Note that the portable device 100 may also be able to charge or operate normally while the headset is charging.

In some embodiments, the headset may charge from electric charge of the portable device 150 via a different port of the portable device, and may not act as an intermediary between a power supply (e.g., a car converter, wall socket power supply, battery, etc.) and the portable device. For example, the portable device may or may not receive charge on a first port (e.g., the charging/docking port 108), and may provide electricity to the headset 150 via a separate port (e.g., a headset port). Thus, the headset may be operable to charge using electricity of the stored energy of the portable device 100 and/or using energy being provided to the portable device 100 via circuitry in the portable device 100, as desired.

Note that the above-described mechanisms for coupling the headset 150 and the portable device 100 are exemplary only, and others are envisioned. For example, in one embodiment, the portable device 100 and the headset 150 may attach to each other using one or more of the methods described above. For example, the headset 150 may be operable to attach to the portable device 100 using a port or a locking mechanism. Alternatively, or additionally, the methods described above may be combined into a single mechanism for attaching the devices. For example, the headset 150 may couple to the portable device 100 using a magnetic adaptor, where the port of the portable device 100 (where the magnetic adaptor is inserted) is also magnetic. Thus, the headset and the device may couple magnetically to a port of the portable device 100. This may be especially advantageous where the headset and the portable device or mistakenly separated, e.g., with excessive force, such that they simply separate without hurting the port or adaptor since the attachment was magnetic. Thus, the portable device 100 and the headset 150 may attach according to numerous different methods, such as those described above, among others.

### FIG. 3—Method for Attaching a Wireless Headset to a Portable Device

FIG. 3 illustrates an exemplary method for attaching a wireless headset to a portable device. The method shown in FIG. 3 may be used in conjunction with any of the systems or devices shown in the above Figures, among other devices. In various embodiments, some of the method elements shown may be performed concurrently, performed in a different order than shown, or omitted. Additional method elements may also be performed as desired. As shown, this method may operate as follows.

In 302, a wireless headset (e.g., the headset 150) may be attached to a portable device (e.g., the portable device 100). As described above, the two devices may be attached according to a variety of different methods, as desired. Note that embodiments of the headset and portable device are not limited to those mechanisms described herein, but may apply to any means for physically attaching the two devices within a close proximity (e.g., 1-10 millimeters, 1-2 centimeters, <1″, etc.). Thus, the wireless headset and the portable device may be attached.

As noted above, while attached, the wireless headset may be operable to charge its battery using stored power of the portable device and/or charge being provided to the portable device. In one embodiment, the wireless headset may only charge its battery while a power supply is connected and charging the portable device and/or the wireless headset (e.g., regardless of whether the headset is inserted before or after the portable device in the power supply connection). Alternatively, the wireless headset may charge until full whether or not the portable device is being charged, by using charge stored in the battery of the portable device and/or electricity being supplied to the portable device, as desired. Thus, while attached to the portable device, the wireless headset may be charged (i.e., the battery of the wireless headset may be charged), according to a variety of methods, such as those described above, among others.

In 304, the wireless headset may be detached from the portable device. In primary embodiments, the wireless headset may be detached by a user of the portable device in order to use the wireless headset.

After removal or detachment of the wireless headset from the portable device, in 306, the wireless headset may wirelessly receive audio data from the portable device using a data receiver of the wireless headset. The audio data may include playback of songs (e.g., where the portable device is a music player or includes music playing functionality), the provision of audio data according to a telecommunication session (e.g., as transmitted from another user using a telephone network, playback of recorded messages, audio/video conferencing, instant messaging, etc), and/or other types of audio data.

Alternatively, or additionally, the wireless headset may be used to wirelessly transmit audio data from the wireless headset, e.g., using an audio transmitter included in the wireless headset. The audio data may include, for example, voice data to be provided to another user in a telecommunication session, voice commands to invoke functionality on the portable device (e.g., starting and stopping playback, dialing a number, transcribing spoken voice to text on the portable device, etc.), and/or other types of audio data.

Note that the data receiver and/or transmitter on the wireless headset may receive data other than audio data. For example, in one embodiment, the wireless headset may include a display and data may be transmitted to the wireless headset for displaying that information. Additionally, or alternatively, the data may include commands/protocol information used during operation of the portable device and the headset. For example, if a user presses an interface button on the headset, data may be transmitted to the portable device indicating that the button has been pressed, which may result in the invocation of functionality on the portable device (e.g., starting or stopping of music when the button is pressed). Thus, the headset may transmit and/or receive data other than audio data in addition to the audio data described above.

In one embodiment, removal or detachment of the wireless headset may be used to invoke functionality of the portable device. For example, audio data may begin to be transmitted to the wireless headset (e.g., by the portable device) when the headset is removed from the portable device. In one embodiment, detachment of the wireless headset from the portable device may be used to accept a telecommunication session (e.g., a phone call received to the portable device). Alternatively, or additionally, detachment of the wireless headset may be used to initiate functionality on the portable device. For example, in one embodiment, the user may remove the wireless headset from the portable device and music may begin playing (or other functionality may be invoked) automatically.

Alternatively, when removed, the portable device may request an action from the user via the portable device. For example, when the user removes the wireless headset, the portable device may issue a request, e.g., via audio data, requesting an action from the user. As one specific example, the portable device may send an audio recording for playback on the wireless headset, such as, “Who would you like to call?” or “What action would you like to perform?” or the like. In one embodiment, the user may then invoke vocal commands to perform functionality of the portable device. For example, the user may simply say “Call Mike” into the headset, and correspondingly, the portable device (in this case including telecommunication capabilities) will initiate a telecommunication session with “Mike” (as looked up in a stored address book in the portable device or on some other server). Thus, a variety of actions may be performed automatically in response to removal or detachment of the wireless headset from the portable device.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A wireless headset, comprising:
a data receiver for receiving audio data from a portable device;
a physical mechanism to attach to the portable device;
wherein the wireless headset is detachable from the portable device, and wherein, after being detached, the headset is usable for listening to the audio data received from the portable device via the data receiver.

2. The wireless headset of claim 1, further comprising:
a data transmitter for providing audio data to the portable device;
wherein, after being detached, the headset is usable for providing the audio data to the portable device via the data transmitter.

3. The headset of claim 1, further comprising:
a rechargeable battery; and
charging circuitry coupled to the battery, wherein, when the headset is coupled to the portable device via the physical mechanism, the charging circuitry is operable to receive electric charge and provide the electric charge to the rechargeable battery for charging.

4. The headset of claim 1, wherein the portable device comprises a mobile telephone.

5. The headset of claim 1, wherein the portable device is operable to perform telecommunication.

6. The headset of claim 5, and wherein removal of the headset from the portable device allows a user to accept an audio telecommunication session received by the portable device.

7. The headset of claim 1, wherein removal of the headset from the portable device allows a user to begin listening to audio from the portable device.

8. The headset of claim 1, wherein the portable device comprises a personal digital assistant.

9. The headset of claim 1, wherein the portable device comprises a laptop computer.

10. The headset of claim 1, wherein the headset is operable to communicate with the portable device according to a Bluetooth communication protocol.

11. The headset of claim 1, wherein the portable device comprises a data storage device.

12. A method, comprising:
attaching a wireless headset to a portable device;
detaching the wireless headset from the portable device; and
the wireless headset wirelessly receiving audio data from the portable device, wherein said wirelessly receiving is performed after said detaching the wireless headset.

13. The method of claim 12, further comprising:
the wireless headset wirelessly providing audio data to the portable device, wherein said wirelessly providing is performed after said detaching the wireless headset.

14. The method of claim 12, further comprising:
charging a battery of the wireless headset while the wireless headset is attached to the portable device.

15. The method of claim 12, wherein the portable device is operable to perform telecommunication.

16. The method of claim 15, wherein said detaching the wireless headset from the portable device operates to accept an audio telecommunication session received by the portable device, and wherein said wirelessly receiving audio data comprises wirelessly receiving audio data of the telephone call.

17. The method of claim 12, wherein said wirelessly receiving audio data from the portable device is performed in response to said detaching the wireless headset from the portable device.

18. The method of claim 12, wherein the portable device comprises a personal digital assistant.

19. The method of claim 12, wherein the portable device comprises one or more of:
a portable audio device;
a data storage device; or
a laptop computer.

20. The method of claim 12, wherein said wirelessly receiving audio data is performed according to a Bluetooth communication protocol.
